(19) United States
(12) Patent Application Publication
(10) Pub. No.: US 2003/0161147 A1
(43) Pub. Date: Aug. 28, 2003

(54) Uninterruptible power system's built-in lighting equipment

(75) Inventor: Herlin Chang, Shen Keng Shiang (TW)

Correspondence Address: BACON & THOMAS, PLLC, 625 SLATERS LANE, FOURTH FLOOR, ALEXANDRIA, VA, 22314

(73) Assignee: Digi Power Manufacturing Inc., Taipei City (TW)

(21) Appl. No.: 10/083,363

(22) Filed: Feb. 27, 2002

(51) Int. Cl. F21L 4/00

(52) U.S. Cl. 362/186; 362/433; 362/375; 362/311

(57) ABSTRACT

A compact sized UPS' built-in lighting equipment is disclosed. It is essentially composed of a light source, a shade, a shade, a holder ring, a fixing device, and an erected stand. By erecting the stand in the shade perpendicular to the shade axis instead of protruding the lamp holder parallelly backwards to the shade axis as that has been practically adopted in conventional techniques so as to attain the purpose of minimizing the equipment size. Besides, provision of switch means makes it possible to control ON/OFF of the power supply to the lighting equipment so as to effectively utilize the electrical energy.

### BACKGROUND OF THE INVENTION

1. Field of the invention

The present invention relates to an uninterruptible power system's (UPS) built-in lighting equipment, and more particularly, to an UPS with a compact size built-in lighting equipment.

2. Description of the Prior Art

FIG. 1 is a schematic view of a conventional lighting luminaire with a lamp installed therein. As shown in FIG. 1, the lighting luminaire has a shade 11 provided with a central opening, a lamp holder 12 having formed with internal threads 121 is protruded backwards from the opening of the shade 11 so as to screw engage with outer threads 131 provided on the base of a lamp 13. The aforesaid combination of the lamp 13 and its holder 12 is then placed in the shade 11 and is connected to an power supply source behind the lighting equipment with a pair of conductors. With this structure, the entire installation will be rather bulky by reason that the combined lamp 13 and its holder is inserted perpendicular to the front surface of the shade 11 into the central opening thereof.

From the above description, it is understood that the structure of a typically constructed lighting equipment has a disadvantage of too bulky volume therefore is not suitable for installing in an UPS whose size should be compact.

The present invention has come to solving the aforesaid problems by the inventors consistent trial and error efforts for a long time. Now it will be elucidated as follows.

### SUMMARY OF THE INVENTION

It is an object of the present invention to provide an UPS' built-in lighting equipment having a simplified structure and effectively minimized size.

It is another object of the present invention to provide an UPS' built-in lighting equipment having a switch for controlling ON/OFF of the power supply to the lighting equipment so as to effectively utilize the electrical energy.

To achieve the above mentioned objects, the UPS' build-in lighting equipment comprises a front housing, a rear housing, a light source, a shade, a holder ring, a fixing device, and an erected stand. By erecting the stand in the shade, the backward protruded portion of combined light source and the holder ring can be largely cut off thereby effectively minimizing the entire structural size and saving the production cost. Besides, provision of switch means makes it possible to control ON/OFF of the power supply to the lighting equipment so as to effectively utilize the electrical energy.

### BRIEF DESCRIPTION OF THE DRAWINGS

For fuller understanding of the nature and objects of the invention, reference should be made to the following detailed description taken in conjunction with the accompanying drawings in which:

FIG. 1 is a schematic view of a conventional lighting luminaire with a lamp installed therein.

FIG. 2(a) is a three dimensional exploded view of the lighting equipment according to the present invention;

FIG. 2(b) is a three dimensional exploded view of the lighting equipment having a power control ON/OFF switch in another embodiment of the present invention;

FIG. 3 is the assembled view of the lighting equipment according to the present invention;

FIG. 4 is the assembled view of the switchable lighting equipment in another embodiment of the present invention; and

FIG. 5 is a illustrative view of the UPS containing a switchable built-in lighting equipment in another embodiment of the present invention.

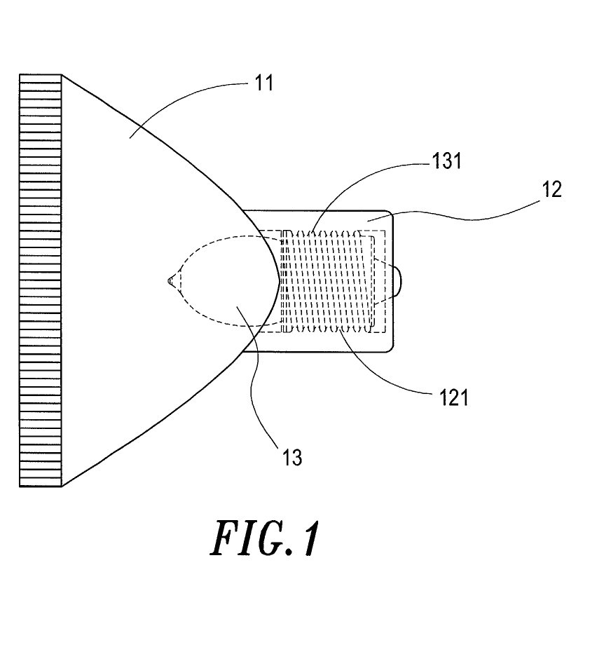

### DETAILED DESCRIPTION OF THE PREFERRED EMBODIMENT

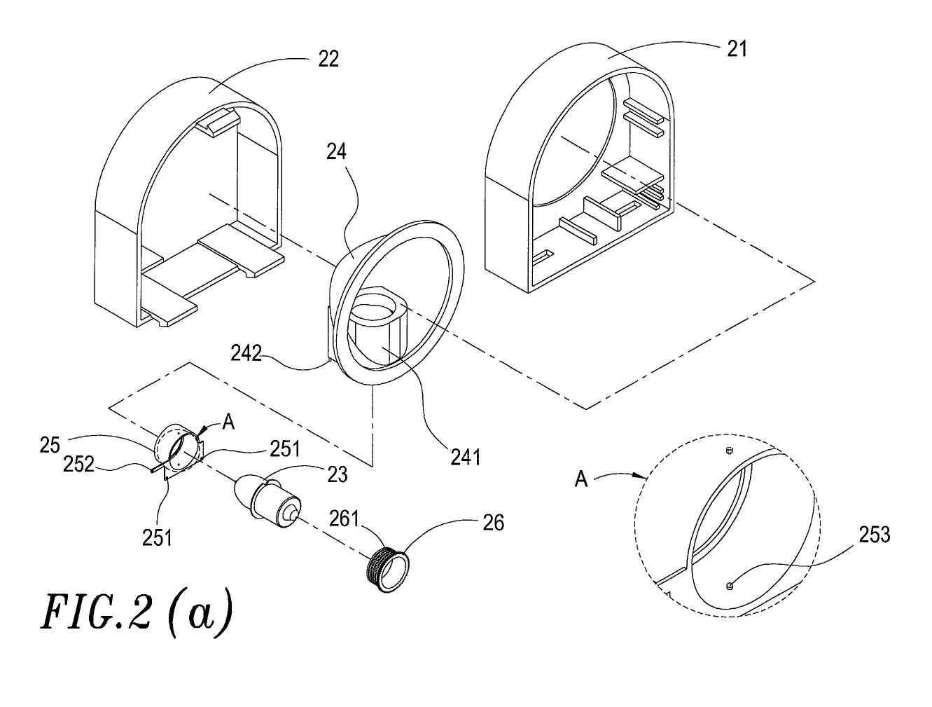

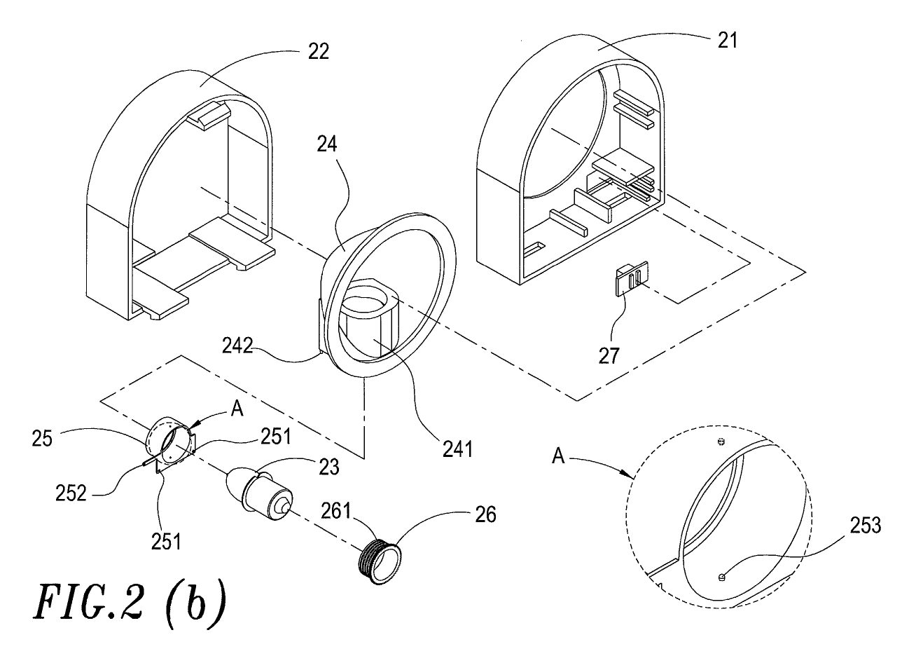

Referring firstly to FIG. 2(a) and FIG. 3, wherein the UPS' built-in lighting equipment of the present invention comprises a front housing 21, a rear housing 22, a light source 23, a shade 24, a holder ring 25, and a fixing device 26. The cavity of the shade 24 is formed into a parabolic figure having a hollow stand 241 erected beneath it. A protuberance 242 is formed at a bottom portion of the stand 241. A containment hole 251 together with a via hole for conductors to pass through is extended out of the holder ring 25, and several protrusions 253 are provided on the inner surface of the holder ring 25. The fixing device 26 is hollow and provided with outer screw threads 261.

The holder ring 25 is coupled with the stand 241 by inlaying the protuberance 242 into the containment hole 251 after the holder ring 25 is set in the cavity of the stand 241 from the bottom of the stand 241, and then the light source 23 is put into the holder ring 25 from underneath thereof, and the protrusions 253 of the holder ring 25 are engaged with the outer threads 261 of the fixing device 21 by rotating the holder ring 25 such that the light source 23 is tightly held therein. After that the aforesaid assembly is settled in the front housing 21 and the rear housing 22, and a pair of conductor wires 31 are connected to the electrical source behind through a hole opened on the rear housing 22.

With this structure, the required installing space for the lighting equipment of the present invention is greatly saved by erecting the stand 241 perpendicular to the shade axis instead of protruding the lamp holder parallelly backwards to the shade axis as that has been practiced in conventional techniques so as to attain the purpose of minimizing the light equipment size.

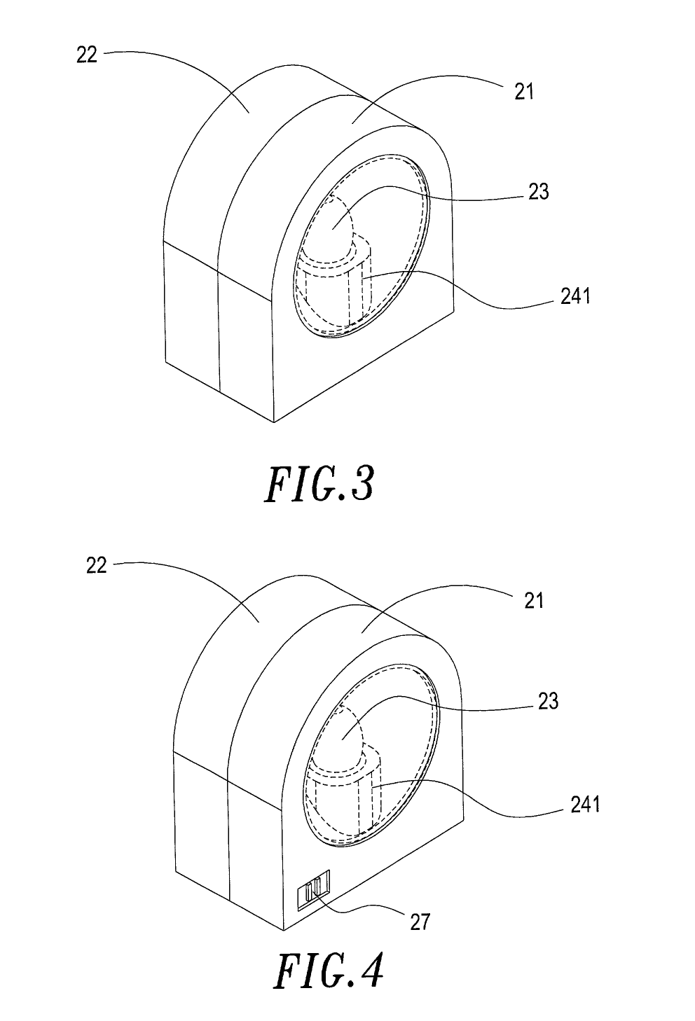

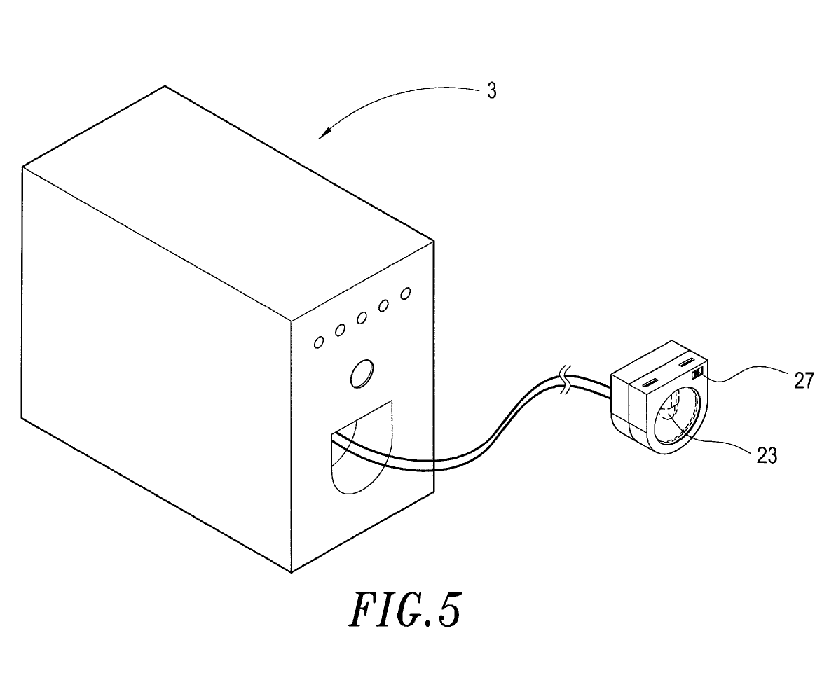

Referring to FIGS. 2(b), 4, and 5, in this embodiment of the present invention a switch 27 is added on the front housing 21 or the rear housing 22 so as to control switching the power supply to the light source 23. In this version, in case the utility power is out, a plurality of such switchable UPS 3 can be used to illuminate surroundings with their light sources 23 simultaneously or a part of the lighting source of the UPS 3 can be switched off if not so much lighting is required thereby saving the energy.

It emerges from the description of the above example that the invention has several noteworthy advantages, in particular:

1. The structure of the lighting equipment of the present invention is simplified and the size thereof is effectively reduced.

2. The provision of a switch to control the power supply to the lighting equipment results in a good effect of preventing wasting energy.

A variety of modifications and variations of the present invention are possible in light of the above teachings. It is therefore to be understood that within the scope of the appended claims, the present invention may be practiced otherwise than as specially described hereinabove.

What is claimed is:

1. An UPS' built-in lighting equipment comprising:
a parabolic figured shade having a stand erected beneath;
a holder ring conjoined with the stand of said shade;
a light source; and
a fixing device engaged with said holder ring for tightening securely said light source;
said stand is formed into hollow structure and has a protuberance formed at the bottom portion thereof, a containment hole is extended out of said holder ring for connection with electric conductors to get power supply, several protrusions are provided on the inner surface of said holder ring, while said fixing device is made hollow and provide with outer screw threads, said holder ring is coupled with said stand by inlaying said protuberance into a containment hole formed on said holder ring after said holder ring is set in the cavity of said stand from the bottom of said stand, and then said light source is put into said holder ring from underneath thereof, and said protrusions of said holder ring are engaged with the outer thread of said fixing device by rotating said holder ring such that said light source is tightly held therein, after that the above assembly is settled in a front housing and a rear housing of said lighting equipment.

2. The lighting equipment of claim 1, wherein a switch is attached to said front housing of said lighting equipment for controlling power supply to said light source.

3. The lighting equipment of claim 1, wherein a switch is attached to said rear housing of said lighting equipment for controlling power supply to said light source.
